(19) United States
(12) Patent Application Publication
(10) Pub. No.: US 2010/0040345 A1
(43) Pub. Date: Feb. 18, 2010

(54) AUTOMATIC DETECTION OF PROGRAM SUBJECT MATTER AND SCHEDULING PADDING

(76) Inventors: Brian Beach, Columbus, IN (US); Alan Waterman, Merced, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/189,982

(22) Filed: Aug. 12, 2008

(51) Int. Cl. H04N 5/91

(52) U.S. Cl. 386/83

(57) ABSTRACT

A DVR user instructs the DVR to record a program. The DVR determines whether the program is of a particular type. If the program is of the particular type, then the DVR presents, to the DVR user, a user interface that enables the DVR user to alter the parameters of the time interval during which the DVR will record the program. After the user has modified the recording time parameters (e.g., start and end recording times) for the program using DVR-presented user interfaces, the DVR stores the modified recording time parameters on the DVR's hard disk drive. The DVR then automatically records the program, beginning and ending at the stored times as modified by the DVR user (rather than the EPG data-specified times).

### FIELD OF THE INVENTION

Embodiments of the invention generally relate to digital video recorders (DVRs). Embodiments of the invention relate more specifically to techniques for automatically altering the recording schedule for an upcoming televised program based on that program's content.

### BACKGROUND

The approaches described in this section could be pursued, but are not necessarily approaches that have been previously conceived or pursued. Therefore, unless otherwise indicated herein, the approaches described in this section are not necessarily prior art to the claims in this application and are not admitted to be prior art by inclusion in this section.

Sophisticated, modern DVRs are capable of scheduling the recordings of programs that are to be televised some time in the future. If a DVR user is interested in recording all episodes of a televised series, then the DVR user can instruct his DVR to get a “season pass” for that series. In response to such an instruction, the DVR automatically determines, from electronic programming guide (“EPG”) data, times at which episodes of that series are going to be televised in the future. Usually, whenever an episode of the selected series is about to be broadcasted, the DVR automatically tunes to the channel on which the episode is going to be broadcasted and records that episode on the DVR's hard disk drive. For as long as the recorded episode remains on the DVR's hard disk drive, the DVR's user can instruct the DVR to replay the episode to the user's television. Conveniently, this allows the DVR user to watch programs in which the user is interested at times other than those program's broadcasting times. The DVR user does not even need to know, beforehand, the exact times at which those programs are going to be broadcasted.

As used herein, a “program” is any content, visual and/or audible, that is presented through a television's display and/or speakers. For example, a program might be an episode of a multi-episode series, a movie, a sporting event, or a news presentation, although this is not an exclusive list of “programs.” When a DVR schedules a program for future recording, the DVR attempts to add the program to a “to do” list that the DVR maintains within the DVR's own storage mechanisms. Whenever a program on the DVR's “to do” list is broadcasted, the DVR automatically records that program.

Typically, a DVR will attempt to determine, from the EPG data mentioned above, at what times a to-be-recorded program will begin and end. For many kinds of programs, such times are accurate and sufficient. Usually, if the DVR begins recording a program at the EPG-provided start time and stops recording the program at the EPG-provided end time, the entire program will end up being stored on the DVR's hard disk drive. Under normal circumstances, no parts of the program will be omitted from the recording, and significant portions of other programs that either precede or follow the program will not be included in the recording (which would waste the DVR's hard disk drive space).

Unfortunately, not all programs actually begin and end at the start and end times indicated by the EPG data. For example, broadcasts of live (occurring at roughly the same time as the broadcast) sporting events sometimes will continue significantly beyond the end time that is indicated in the EPG data (this is especially likely if the sporting event involves overtime play). It is often difficult to predict the precise duration of certain live broadcasts. If the DVR stops recording the broadcast of such a program at the EPG-indicated end time, then a significant portion of the end of the program may be omitted from the recording that is stored on the DVR's hard disk drive.

DVR users often rely on their DVR's automatic recording capabilities to record programs that will be broadcast at times that the DVR users cannot watch those programs. Consequently, DVR users often might not be able to instruct their DVRs to continue recording under circumstances when their DVRs are about to stop recording a program whose broadcast is going to continue beyond the EPG-indicated end time. When a DVR user later views a recording that is incomplete because the broadcast of the program lasted longer than was signified by the EPG data, that user may be severely disappointed that he will not be able to watch the end of the program.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates an example of a technique for extending the scheduled recording time interval for a program that a DVR is going to record, according to an embodiment of the invention;

FIG. 2A illustrates an example system in which an embodiment of the invention may be implemented;

FIG. 2B is a block diagram illustrating a general overview of the components of a Digital Video Recorder (DVR), according to an embodiment of the invention;

FIG. 3 is a block diagram that illustrates a digital video recorder upon which an embodiment may be implemented; and

FIG. 4 illustrates an example of a DVR-presented user interface through which a user can specify an amount by which a starting and ending scheduled recording time should be extended beyond what is stated in EPG data.

### DETAILED DESCRIPTION

A method and apparatus for scheduling the recording of upcoming programs, and for extending the duration of the time interval during which those programs will be recorded, is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:

| | |
|---|---|
| 1.0 | General Overview |
| 2.0 | DVR Overview |
| 3.0 | Program Type-Based Extension of Recording Time Duration |
| 4.0 | Implementation Mechanisms - Hardware Overview |
| 5.0 | Extensions and Alternatives |

### 1.0 General Overview

The needs identified in the foregoing Background, and other needs and objects that will become apparent for the following description, are achieved in the present invention, which comprises, in one aspect, a technique whereby, in response to determining that the content of an upcoming televised program is of a particular type, a DVR invites a user to extend the specified duration of a planned future recording of the program.

According to one embodiment of the invention, when a DVR user instructs the DVR to record a program (e.g., a single program or a multi-episode series) that is going to be broadcast at some future time (or a program that is currently being broadcasted), the DVR determines whether the program, or the content thereof, is of a particular type. If the program, or the content thereof, is of the specified type, then the DVR presents (e.g., via a television screen), to the DVR user, a menu that contains an option which, when selected by the DVR user (e.g., via the DVR remote control), enables the DVR user to alter the parameters of the time interval during which the DVR will record the program.

For example, a DVR user might instruct a DVR to record a broadcast of a sporting event program (e.g., a football game, basketball game, baseball game, hockey game, soccer game, boxing match, wrestling match, tennis match, golf tournament, horse race, car race, track and field event, etc.). The DVR may inspect metadata that is associated with the program (e.g., metadata that the DVR obtains from an EPG data provider) to determine that the content of the program represents a sporting event. In response to determining that the program is a sporting event, the DVR may present, to the DVR user, a screen that alerts the DVR user that, unless the DVR modifies the recording time parameters, the entire sporting event might not be recorded (because the EPG data-specified recording time parameters are often inaccurate for programs of that kind). The screen also may contain a menu option labeled “modify recording time parameters.” In response to the DVR user's selection of this menu option, the DVR may present, to the DVR user, a menu that contains user interface elements that allow the user to modify the scheduled times at which the DVR will start and/or stop recording the program. In one embodiment of the invention, these times are initially set to the starting and ending times that are indicated in the EPG metadata that is associated with the program. By manipulating the user interface elements, the DVR user may modify the scheduled times if the user wishes to do so.

In the foregoing embodiment of the invention, after the user has modified the recording time parameters (e.g., start and end recording times) for the program using DVR-presented user interfaces, the DVR stores the modified recording time parameters on the DVR's hard disk drive. The DVR then automatically records the program, beginning and ending at the stored times as modified by the DVR user (rather than the EPG data-specified times). To do this, in one embodiment of the invention, the DVR determines whether the current time is the stored starting time for the program. If the DVR determines that the current time is the stored starting time, then the DVR tunes to the channel on which the program is scheduled to be broadcasted (as indicated in EPG metadata associated with the program) and begins recording audio and video content that is being broadcasted on that channel. Alternatively, if the program is currently being broadcasted at the time that the DVR user instructs the DVR to record the program, then the DVR tunes to the channel on which the program is scheduled to be broadcasted (if the DVR is not already tuned to that channel) and begins recording audio and video content that is being broadcasted on that channel.

While the DVR is recording broadcasted content, the DVR determines whether the current time is the stored ending time for the program. If the DVR determines that the current time is the stored ending time, then the DVR stops recording the broadcasted content that the DVR had been recording. In one embodiment of the invention, the DVR ensures that scheduled recordings of other programs will not interrupt the recording of the program for which the user altered the recording time parameters. The DVR may ignore, partially clip, or reschedule the scheduled recordings of such other programs, for example.

In other aspects, embodiments of the invention encompass a computer apparatus and a computer-readable storage medium configured to carry out the foregoing technique.

### 2.0 Structural Overview

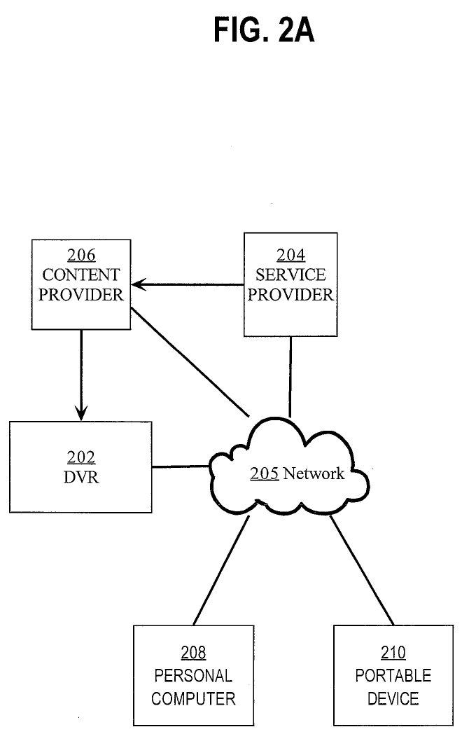

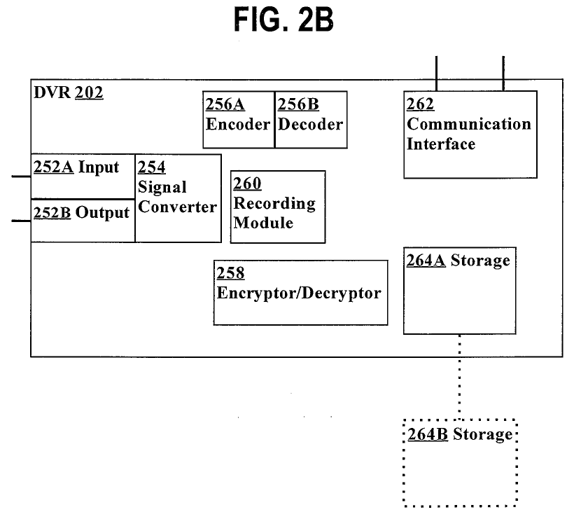

FIG. 2A illustrates an example system in order to automatically pad the recording of content, according to an embodiment. The system contains at least one client device such as DVR 202 which is communicatively coupled to network 205 through any communication interface, such as an Ethernet interface or wireless communications port. The functionality of a DVR is typified in U.S. Pat. No. 6,233,389, which is owned by the Assignee and is hereby incorporated by reference. The system also includes service provider 204, content provider 206, personal computer 208 and portable device 210.

Personal computer 208 may be a personal computing device, such as a desktop computer or laptop computer, and is also coupled to network 205 through any communications interface, including wireless. Portable device 210 may be any handheld computing device, cellular phone, portable media player, or any other portable device capable of displaying multimedia content and may be coupled to network 205 through any communications interface, including wireless. DVR 202, personal computer 208, and portable device 210 each communicate with service provider 204 through network 205. In another embodiment, DVR 202, personal computer 208, and portable device 210 each communicate with content provider 210 through network 205.

Network 205 may be implemented by any medium or mechanism that provides for the exchange of data between devices in the communication system. Examples of network 205 include, without limitation, a network such as a Local Area Network (LAN), Wide Area Network (WAN), the Internet, one or more terrestrial, satellite or wireless links, etc. Alternatively or additionally, any number of devices connected to network 205 may also be directly connected to each other through a communications link.

In one embodiment, content provider 206 provides broadcast program content to DVR 202 via cable, satellite, terrestrial communication, or other transmission method. Broadcast program content may include any multimedia content such as: audio, image, or video content. In another embodiment, content provider 206 provides multimedia content, such as any downloadable content, through network 205 to DVR 202, personal computer 208, or portable device 210.

In one embodiment, DVR 202 communicates with service provider 204, which provides program guide data, graphical resources (such as fonts, pictures, etc.), service information, software, advertisements, event identification data, and other forms of data enable DVR 202 to operate independently of service provider 204 to satisfy user interests. In another embodiment, DVR 202, personal computer 208, and portable device 210 can communicate with each other to transfer content, metadata, or any other data through network 205, communication connection, or any local network.

In another embodiment, content provider 206 may provide, to service provider 204, content data or any metadata, including promotional data, icons, web data, and other information. Service provider 204 may then interpret the metadata and provide the content data metadata to DVR 202, personal computer 208, or portable device 210.

Referring to FIG. 2B, in an embodiment, DVR 202 generally comprises a plurality of components, signified by Signal Converter 254, that are necessary to digitize an analog television signal and convert it into a digital data stream or accept a digital data stream. An example of the internal structure and operation of a DVR is further described in U.S. Pat. No. 6,233,389.

DVR 202 receives broadcast signals from an antenna, from a cable TV system, satellite receiver, etc., via input 252A. Input 252A may comprise a plurality of tuning modules that allow a plurality of signals to be received and recorded simultaneously. For example, a TV input stream received by input 252A may take the form of a National Television Standards Committee (NTSC) compliant signal or a PAL compliant broadcast signal. For another example, a TV input stream received by input 252A may take a digital form such as a Digital Satellite System (DSS) compliant signal, a Digital Broadcast Services (DBS) compliant signal, or an Advanced Television Standards Committee (ATSC) compliant signal. DBS, DSS, and ATSC are based on standards called Moving Pictures Experts Group 2 (MPEG-2) and MPEG-2 Transport. MPEG-2 Transport is a standard for formatting the digital data stream from the TV source transmitter so that a TV receiver can disassemble the input stream to find programs in the multiplexed signal.

An MPEG-2 transport multiplex supports multiple programs in the same broadcast channel with multiple video and audio feeds and private data. Input 252A tunes to a particular program in a channel, extracts a specified MPEG stream from the channel, and feeds the MPEG stream to the rest of the system. Analog TV signals are encoded into a similar MPEG format using separate video and audio encoders, such that the remainder of the system is unaware of how the signal was obtained. Information may be modulated into the vertical blanking interval (VBI) of the analog TV signal in a number of standard ways; for example, the North American Broadcast Teletext Standard (NABTS) may be used to modulate information onto certain lines of an NTSC signal, which the FCC mandates the use of a certain other line for closed caption (CC) and extended data services (EDS). Such signals are decoded by input 252A and passed to the other modules as if the signals had been delivered via an MPEG-2 private data channel.

Recording Module 260 records the incoming data stream by storing the digital data stream on at least one storage facility, signified by Storage 264A/164B that is designed to retain segments of the digital data stream. Storage 264A/164B may be one or more non-volatile storage devices (e.g., hard disk, solid state drive, USB external hard drive, USB external memory stick, USB external solid state drive, network accessible storage device, etc.) that are internal 264A and/or external 264B. A Signal Converter 254 retrieves segments of the data stream, convert the data stream into an analog signal, and then modulate the signal onto a RF carrier, via Output 252B, through which the signal is delivered to a standard TV set. Output 252B may alternatively deliver a digital signal to a TV set or video monitor. For example, DVR 202 may utilize a Digital Visual Interface port (DVI) for sending digital signals to a TV via a DVI cable.

DVR 202 also includes a Communication Interface 262, through which the DVR 202 communicates with Network 205 via Ethernet, wireless network, modem, or other communications standard. Further, DVR 202 may be integrated into a TV system such that the components described above are housed in a TV set capable of performing the functions of each component of DVR 202.

In another embodiment, DVR 202 generally comprises a plurality of components necessary to receive, record, store, transfer and playback digital data signals from a plurality of sources, such as a PC, a DVR, a service provider, or content server. DVR 202 can transfer digital data signals to another DVR or PC. DVR 202 may encode or decode digital signals via Encoder 256A and Decoder 256B into a plurality of formats for playback, storage or transfer. According to one embodiment of the invention, encoder 256A produces MPEG streams. According to another embodiment of the invention, encoder 256A produces streams that are encoded using a different codec. Decoder 256B decodes the streams encoded by encoder 256A or streams that are stored in the format in which the streams were received using an appropriate decoder. DVR 202 can also encrypt or decrypt digital data signals using Encryptor/Decryptor 258 for storage, transfer or playback of the digital data signals.

In one embodiment, DVR 202 communicates with Service Provider 204, which provides program guide data, graphical resources such as brand icons and pictures, service information, software programs, advertisements, and other forms of data that enable DVR 202 to operate independently of the Service Provider 204 to perform autonomous recording functions. Communication between DVR 202 and Service Provider 204 utilizes a secure distribution architecture to transfer data between the DVR 202 and the Service Provider 204 such that both the service data and the user's privacy are protected.

### 3.0 Program Type-Based Extension of Recording Time Duration

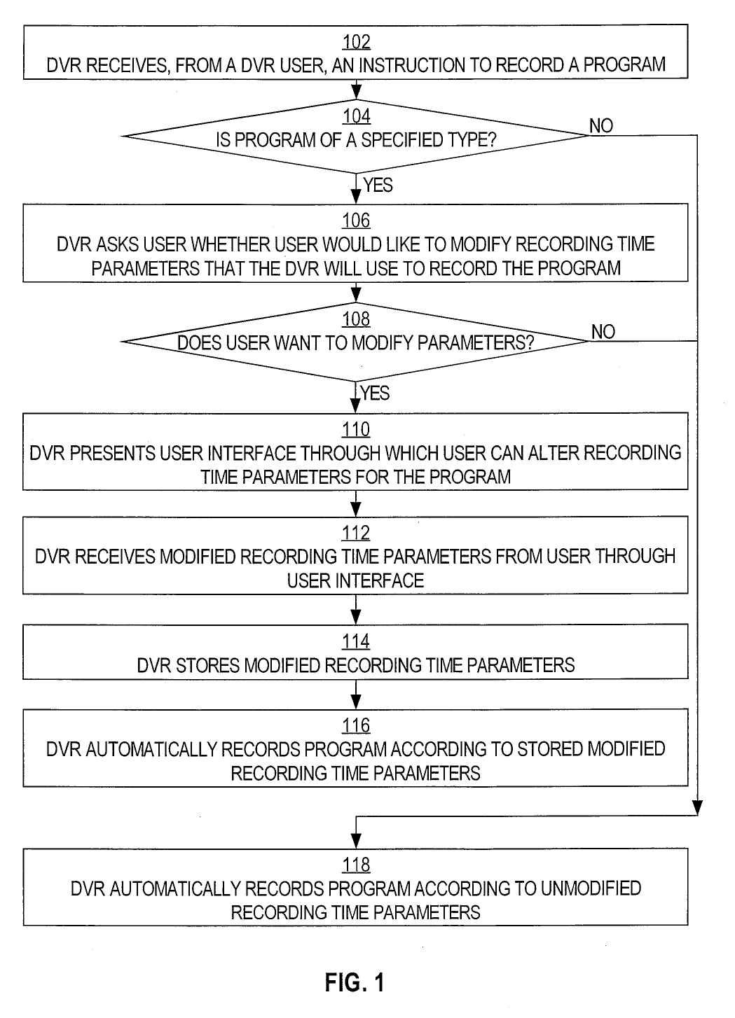

FIG. 1 is a flow diagram that illustrates an example of a technique for extending the scheduled recording time interval for a program that a DVR is going to record, according to an embodiment of the invention. In one embodiment of the invention, at least some of the steps of the illustrated technique are performed by the DVR shown in FIG. 2. Alternative techniques, according to various alternative embodiments of the invention, may comprise fewer, greater, or different steps than those illustrated in FIG. 1.

Referring now to FIG. 1, in block 102, a DVR receives, from a DVR user, an instruction to record a program. The DVR may receive this instruction in the form of the DVR user's selection (e.g., via the DVR remote control) of a program that is shown in a DVR-presented program guide. Such a program guide may show the dates, times, and channels on which various program are scheduled to be broadcasted, as indicated within EPG data. Alternatively, the DVR user may instruct the DVR to record the program using some mechanism other than the program guide.

In block 104, in response to receiving the instruction, the DVR determines whether the user-selected program is of a specified type (which may be any of a specified set of multiple different specified types). For example, in one embodiment of the invention, the DVR determines whether the program, or the content thereof, is of a “sporting event” type. In one embodiment of the invention, the DVR determines the type of the program, or the content thereof, from a program type indication that is contained in metadata that is associated with the program. In one embodiment of the invention, the DVR obtains such metadata over a network from an EPG data provider. A program's type may be based on that program's specified “category.” Additionally or alternatively, a program's type may be based on that program's specified “genre.” If the program is of the specified type, then control passes to block 106. Otherwise, control passes to block 118. There are various ways by which types may be defined, and also various ways by which programs may become members of a particular type. In one embodiment of the invention, the user of the DVR defines custom types of his own creation using the DVR's controls. The DVR stores these custom user-defined types. In such an embodiment of the invention, the user can then select programs from an electronic program guide (again, using the DVR's controls) and assign custom user-defined types to those programs. The DVR responsively stores the user-specified program-to-type associations. In an alternative embodiment of the invention, a service provider (e.g., the provider of the EPG data discussed above, or the provider of the content that is delivered to the DVR) additionally or alternatively defines program types and associates programs with those types. A program may be associated with multiple types-some of the types with which a particular program is associated may be DVR user-defined, while other types with which that same particular program is associated may be defined by some service provider other than the DVR user. In various embodiments of the invention, users and/or service providers have the capability to delete and/or modify both types and the associations between types and programs, regardless of whether those types and associations were originally defined by those users and/or service providers themselves, or by others.

In block 106, in response to determining that the program is of the specified type, the DVR asks the DVR user (e.g., via a screen that the DVR presents to the DVR user on a television display) whether the DVR user would like to modify the recording time parameters (e.g., the start and end recording times) that the DVR will use to record the program. In connection with asking the DVR user whether the DVR user would like to modify these parameters, the DVR also may alert and warn that user that, because the program is of the specified type (e.g., sporting event), the entire program might not be recorded unless the DVR takes this opportunity to instruct the DVR to modify the recording time parameters (e.g., by changing the scheduled time at which the DVR will stop recording the program).

In block 108, the DVR receives, from the DVR user, an indication of whether the DVR user wants to modify the recording time parameters that are associated with the program. If the DVR user indicates to the DVR that the DVR user wants to modify the recording time parameters, then control passes to block 110. Otherwise, control passes to block 118.

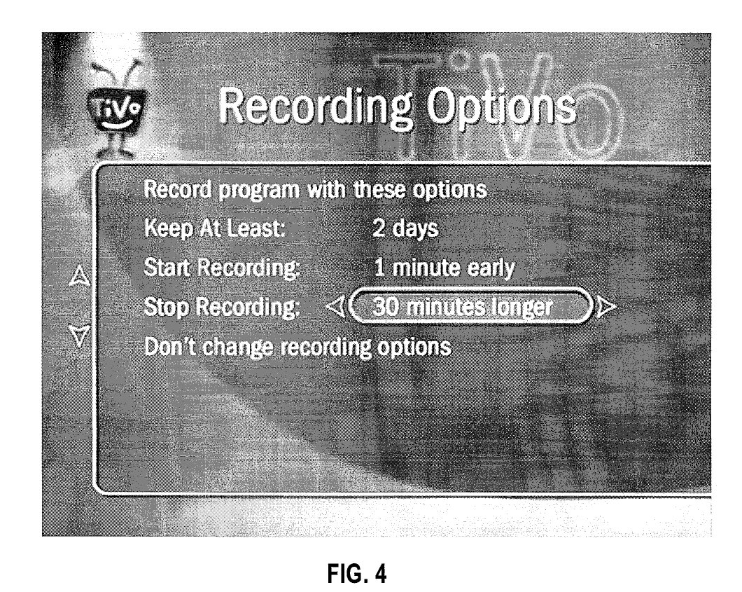

In block 110, the DVR presents, to the DVR user (e.g., via a screen that the DVR presents to the DVR user on a television display) a user interface that contains user interface elements via which the user can alter the starting and ending recording times that are associated with the program. For example, in the user interface, the DVR may present the starting recording time in one user-modifiable field, and the DVR may present the ending recording time in another user-modifiable field. The DVR user may navigate between fields using buttons on the DVR remote control. The DVR user may alter the values of the fields either by pressing number buttons on the DVR remote control or by pressing an “up” button (to increase a value in a field that currently has focus) or a “down” button (to decrease a value in a field that currently has focus). Additionally or alternatively, in one embodiment of the invention, the user interface may contain a user-selectable menu option which, when selected by the DVR user, automatically moves the scheduled ending time value later by a specified temporal increment (e.g., one hour). Additionally or alternatively, in one embodiment of the invention, the scheduled start time value may similarly be moved by a specified temporal increment. In either embodiment of the invention, the user interface may contain user-selectable menu options for causing the DVR to save and apply the values indicated in the fields and for causing the DVR to cancel the modification operation and abandon the values indicated in the fields in favor of the original starting and ending time values. FIG. 4 illustrates an example of a DVR-presented user interface through which a user can specify an amount by which a starting and ending scheduled recording time should be extended beyond what is stated in EPG data. As can be seen in FIG. 4, there is a field through which a user can express how much earlier the starting time should be moved, and also a field through which the user can express how much later the ending time should be moved.

Referring again to FIG. 1, in block 112, the DVR receives, from the DVR user, modified recording time parameters that the user specified via the user interface that the DVR presented to the user in block 110. In one embodiment of the invention, the DVR adds or subtracts user-specified values from original start and/or end times that are associated with a program. The DVR then stores the modified start and/or end times. However, in an alternative embodiment of the invention, the DVR does not modify the original start and/or end times that are associated with a program. Instead, the DVR retains the original start and/or end times, but uses the user-specified parameters to calculate modified times periodically, to determine when to begin and end the recording. Thus, even if the user later further changes the specified time parameters, the DVR can still determine, from the original stored times, when the recording should begin and end.

In block 114, the DVR stores the modified recording time parameters on the DVR's hard disk drive or other persistent storage mechanism.

In block 116, the DVR automatically records the program according to the modified recording time parameters that the DVR stored in block 114. For example, as is discussed above, in one embodiment of the invention, the DVR determines whether the current time is the stored starting time for the program. If the DVR determines that the current time is the stored starting time, then the DVR tunes to the channel on which the program is scheduled to be broadcasted (as indicated in EPG metadata associated with the program) and begins recording audio and video content that is being broadcasted on that channel. Alternatively, if the program is currently being broadcasted at the time that the DVR user instructs the DVR to record the program, then the DVR tunes to the channel on which the program is scheduled to be broadcasted (if the DVR is not already tuned to that channel) and begins recording audio and video content that is being broadcasted on that channel. In one embodiment of the invention, while the DVR is recording broadcasted content, the DVR determines whether the current time is the stored ending time for the program. If the DVR determines that the current time is the stored ending time, then the DVR stops recording the broadcasted content that the DVR had been recording.

Alternatively, in block 118, the DVR schedules the recording of the program to begin at the start time that is already associated with the program, and to end at the end time that is already associated with the program. Such start and end times may be obtained from EPG metadata that is associated with the program, for example.

### 4.0 Implementation Mechanisms-Hardware Overview

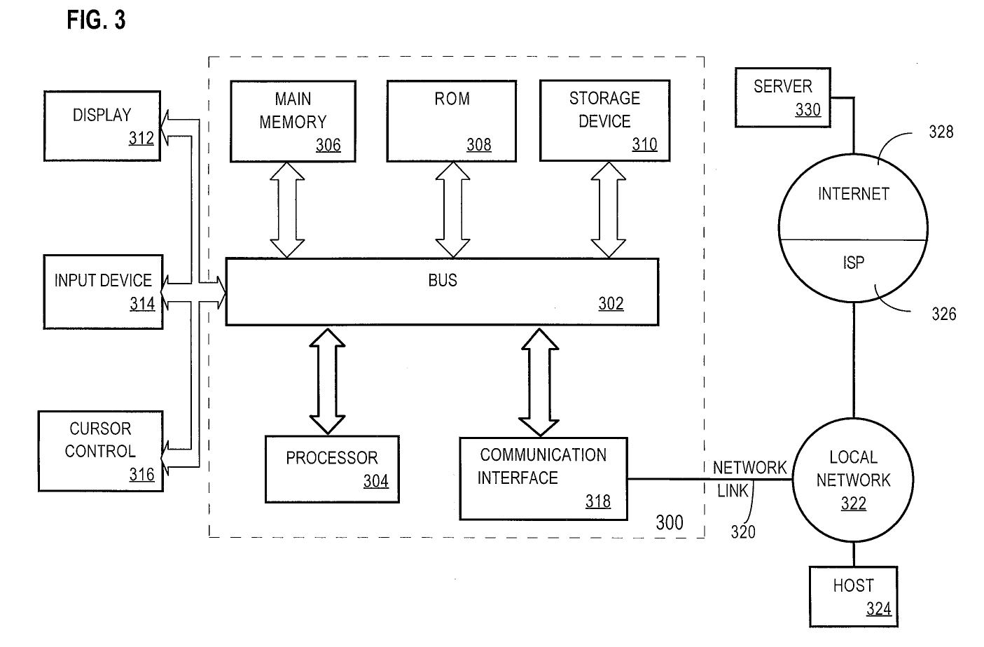

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (“RAM”) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (“ROM”) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (“CRT”), for displaying information to a computer user. An input device 314, including alphanumeric and other keys, is coupled to bus 302 for communicating information and command selections to processor 304. Another type of user input device is cursor control 316, such as a mouse, trackball, stylus, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for selecting a frame of a multi-frame video program for display in accordance with a selected trick play mode of a DVR. According to one embodiment of the invention, selecting a frame of a multi-frame video program for display in accordance with a selected trick play mode of a DVR is provided by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, or any other memory chip or cartridge.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector can receive the data carried in the infrared signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (“ISDN”) card or a modem to provide a data communication connection to a corresponding type of telephone line. As another example, communication interface 318 may be a local area network (“LAN”) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (“ISP”) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

### 5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

For example, although in one embodiment of the invention, the DVR invites the DVR user to modify the scheduled recording time parameters by which the DVR will abide when recording a selected program, in an alternative embodiment of the invention, the DVR instead automatically moves the end recording time for the selected program later by a specified temporal increment (e.g., one hour) whenever the DVR determines that the selected program is of the specified type (e.g., sporting event). In such an alternative embodiment of the invention, the DVR may merely notify the user (e.g., at the time that the user instructs the DVR to record the program) that the DVR has automatically increased the amount of time during which the DVR will record the program. The DVR user does not need to modify the recording time parameters in such an alternative embodiment of the invention.

For another example, although in one embodiment of the invention, the DVR automatically suggests, to the DVR user, modifying or padding the scheduled recording times in response to determining that the program to be recorded (or the content thereof) is a sporting event, in an alternative embodiment of the invention, the DVR automatically makes such a suggestion in response to determining that the program (or the content thereof) is any one of a set of specified program types, which may include types other than sporting events. For example, such a set might include news events, such as political debates. For another example, such a set might include award shows, such as The Oscars, The Golden Globes, The Emmys, The Grammys, The Tonys, or other events at which artists are presented with awards.

For another example, the DVR may prompt a DVR user to modify scheduled recording times as discussed above in response to the DVR determining that the program that is associated (e.g., in metadata) with some indication (e.g., a “flag” contained within the program's metadata) that the broadcast is “live” in nature (i.e., that the event being broadcasted is being broadcasted concurrently with the actual occurrence of the event). Therefore, in one embodiment of the invention, the DVR prompts the user to modify scheduled recording times that are associated with a program in response to the DVR determining that the program is of a “live” type—potentially regardless of the program's “category” or “genre.”

Although in one embodiment of the invention, the DVR prompts a DVR user to modify recording time settings in response to the DVR's determination that a program to be recorded is of a particular type, in an alternative embodiment of the invention, the DVR prompts a DVR user to modify such recording time settings in response to the DVR's determination that some information other than program type (e.g., “category” or “genre”) satisfies some specified criteria. For example, in one alternative embodiment of the invention, the DVR may prompt the user to modify scheduled recording time settings in response to determining that the program is on a particular channel, is scheduled to start at a particular time of day or day of the week, contains a particular actor or actress, has a particular rating, and/or was directed by a particular director.

Although in one embodiment of the invention, the DVR prompts the user to modify scheduled recording times that are associated with a program in response to a determination that the program satisfies some specified criteria, in alternative embodiments of the invention, the DVR additionally or alternatively prompts the user to modify (or automatically modifies) other aspects that pertain to the recording of the program. For example, in one alternative embodiment of the invention, in response to determining that a to-be-recorded program satisfies some specified criteria (such as being of a particular content type like “sporting event”), the DVR prompts the user to modify the “recording quality” at which the DVR will record the program. Higher recording qualities may produce a better viewing experience but also may occupy more space on the DVR's hard disk drive. The default “recording quality” might be less than the highest “recording quality” of which the DVR is capable.

In one embodiment of the invention, in response to a DVR user accepting the DVR's invitation to modify the scheduled recording times for a program, the DVR asks the DVR user how much time should be added to the end of the program. In response to receiving an indication of some time value (e.g., in minutes) from the user, the DVR automatically adjusts and stores the scheduled ending recording time for the program in accordance with the time value.

What is claimed is:

1. A method for adjusting program recording parameters in a digital video recording device, the method comprising:
the digital video recording device determining that a program that the digital video recording device has been instructed to record has a particular characteristic associated with the program;
in response to the digital video recording device determining that the program has the particular characteristic, the digital video recording device prompting a user to adjust program recording parameters in accordance with which the digital video recording device will record the program;
the digital video recording device receiving adjusted program recording parameters from the user; and
the digital video recording device recording the program in accordance with the adjusted program recording parameters.

2. The method of claim 1, wherein the step of the digital video recording device determining that the program has the particular characteristic comprises:
the digital video recording device determining that the program is associated with data that indicates that a broadcast of the program is live.

3. The method of claim 1, wherein the step of the digital video recording device determining that the program has the particular characteristic comprises:
the digital video recording device determining that the program is associated with data that indicates that the program belongs to a program category that is contained in a set of specified program categories.

4. The method of claim 1, wherein the step of the digital video recording device determining that the program has the particular characteristic comprises:
the digital video recording device determining that the program is associated with data that indicates that the program represents a sporting event.

5. The method of claim 1, wherein the step of the digital video recording device prompting the user to adjust program recording parameters in accordance with which the digital video recording device will record the program comprises:
the digital video recording device prompting the user to adjust one or more times at which the digital video recording device's recording of the program is scheduled to begin or end.

6. The method of claim 1, wherein the step of the digital video recording device prompting the user to adjust program recording parameters in accordance with which the digital video recording device will record the program comprises:
the digital video recording device prompting the user to adjust an indication of a quality at which the digital video recording device will record the program.

7. The method of claim 1, wherein the step of the digital video recording device receiving the adjusted program recording parameters from the user comprises:
the digital video recording device receiving, from the user, user input that indicates a change to a time at which the digital video recording device is to begin or end a recording of the program.

8. The method of claim 1, wherein the step of the digital video recording device receiving the adjusted program recording parameters from the user comprises:
the digital video recording device receiving, from the user, user input that indicates a change to a quality with which the digital video recording device is to record the program.

9. The method of claim 1, wherein the step of the digital video recording device recording the program in accordance with the adjusted program recording parameters comprises:
the digital video recording device determining, at a first time, that the first time reflects a time at which the program is scheduled to begin recording;
in response to the digital video recording device determining that the first time reflects the time at which the program is scheduled to begin recording, (a) the digital video recording device tuning to a channel on which the program will be broadcast and (b) the digital video recording device storing, on a persistent storage device, content that is being broadcasted on the channel;
the digital video recording device determining, at a second time, that the second time reflects a time that a user instructed the digital video recording device to stop recording the program; and
in response to the digital video recording device determining that the second time reflects the time that the user instructed the digital video recording device to stop recording the program, the digital video recording device ending a recording of the content that the digital video recording device had been storing on the persistent storage device up until the second time;
wherein the second time differs from a time that an electronic programming guide indicated that a broadcast of the program would conclude.

10. A method for adjusting program recording parameters in a digital video recording device, the method comprising:
the digital video recording device determining that a program that the digital video recording device has been instructed to record has a particular characteristic associated with the program;
in response to the digital video recording device determining that the program has the particular characteristic, the digital video recording device automatically extending an original scheduled recording time interval for the program by a specified amount of time, thereby producing an extended scheduled recording time interval that is longer in duration than the original scheduled recording time interval;
wherein the original scheduled recording time interval, prior to the digital video recording device's extension, is based on a duration of the program as indicated in electronic programming guide data; and
the digital video recording device recording the program in accordance with the extended scheduled recording time interval instead of the original scheduled recording time interval.

11. A digital video recording device that is configured to:
determine that a program that the digital video recording device has been instructed to record has a particular characteristic associated with the program;
prompt, in response to determining that the program has the particular characteristic, a user to adjust program recording parameters in accordance with which the digital video recording device will record the program;
receive adjusted program recording parameters from the user; and
record the program in accordance with the adjusted program recording parameters.

12. The digital video recording device of claim 11, wherein the digital video recording device is configured to determine that the program has the particular characteristic by determining that the program is associated with data that indicates that a broadcast of the program is live.

13. The digital video recording device of claim 11, wherein the digital video recording device is configured to determine that the program has the particular characteristic by determining that the program is associated with data that indicates that the program belongs to a program category that is contained in a set of specified program categories.

14. The digital video recording device of claim 11, wherein the digital video recording device is configured to determine that the program has the particular characteristic by determining that the program is associated with data that indicates that the program represents a sporting event.

15. The digital video recording device of claim 11, wherein the digital video recording device is configured to prompt the user to adjust program recording parameters in accordance with which the digital video recording device will record the program by prompting the user to adjust one or more times at which the digital video recording device's recording of the program is scheduled to begin or end.

16. The digital video recording device of claim 11, wherein the digital video recording device is configured to prompt the user to adjust program recording parameters in accordance with which the digital video recording device will record the program by prompting the user to adjust an indication of a quality at which the digital video recording device will record the program.

17. The digital video recording device of claim 11, wherein the digital video recording device is configured to receive the adjusted program recording parameters from the user by receiving, from the user, user input that indicates a change to a time at which the digital video recording device is to begin or end a recording of the program.

18. The digital video recording device of claim 11, wherein the digital video recording device is configured to receive the adjusted program recording parameters from the user by receiving, from the user, user input that indicates a change to a quality with which the digital video recording device is to record the program.

19. The digital video recording device of claim 11, wherein the digital video recording device is configured to record the program in accordance with the adjusted program recording parameters by performing steps comprising:
determining, at a first time, that the first time reflects a time at which the program is scheduled to begin recording;
in response to determining that the first time reflects the time at which the program is scheduled to begin recording, (a) tuning to a channel on which the program will be broadcast and (b) storing, on a persistent storage device, content that is being broadcasted on the channel;
determining, at a second time, that the second time reflects a time that a user instructed the digital video recording device to stop recording the program; and
in response to determining that the second time reflects the time that the user instructed the digital video recording device to stop recording the program, ending a recording of the content that the digital video recording device had been storing on the persistent storage device up until the second time;
wherein the second time differs from a time that an electronic programming guide indicated that a broadcast of the program would conclude.

20. The digital video recording device of claim 11, wherein the digital video recording device is configured to receive adjusted program recording parameters from the user by receiving, from the user, user input that indicates the user's consent for the digital video recording device to postpone an ending time, at which a scheduled recording of the program is to end, by a specified amount of time.

21. A volatile or non-volatile computer-readable storage medium carrying instructions for causing one or more processors to perform steps for adjusting program recording parameters in a digital video recording device in response to executing the instructions, wherein the steps comprise:
determining at the digital video recording device that a program that the digital video recording device has been instructed to record has a particular characteristic associated with the program;
in response to determining at the digital video recording device that the program has the particular characteristic, prompting, at the digital video recording device, a user to adjust program recording parameters in accordance with which the digital video recording device will record the program;
receiving, at the digital video recording device, adjusted program recording parameters from the user; and
recording the program at the digital video recording device in accordance with the adjusted program recording parameters.

22. The volatile or non-volatile computer-readable storage medium of claim 21, wherein the step of determining that the program has the particular characteristic comprises:
determining that the program is associated with data that indicates that a broadcast of the program is live.

23. The volatile or non-volatile computer-readable storage medium of claim 21, wherein the step of determining that the program has the particular characteristic comprises:
determining that the program is associated with data that indicates that the program belongs to a program category that is contained in a set of specified program categories.

24. The volatile or non-volatile computer-readable storage medium of claim 21, wherein the step of determining that the program has the particular characteristic comprises:
determining that the program is associated with data that indicates that the program represents a sporting event.

25. The volatile or non-volatile computer-readable storage medium of claim 21, wherein the step of prompting the user to adjust program recording parameters in accordance with which the digital video recording device will record the program comprises:
prompting the user to adjust one or more times at which the digital video recording device's recording of the program is scheduled to begin or end.

26. The volatile or non-volatile computer-readable storage medium of claim 21, wherein the step of prompting the user to adjust program recording parameters in accordance with which the digital video recording device will record the program comprises:
prompting the user to adjust an indication of a quality at which the digital video recording device will record the program.

27. The volatile or non-volatile computer-readable storage medium of claim 21, wherein the step of receiving the adjusted program recording parameters from the user comprises:
receiving, from the user, user input that indicates a change to a time at which the digital video recording device is to begin or end a recording of the program.

28. The volatile or non-volatile computer-readable storage medium of claim 21, wherein the step of receiving the adjusted program recording parameters from the user comprises:
receiving, from the user, user input that indicates a change to a quality with which the digital video recording device is to record the program.

29. The volatile or non-volatile computer-readable storage medium of claim 21, wherein the step of recording the program in accordance with the adjusted program recording parameters comprises:
determining, at a first time, that the first time reflects a time at which the program is scheduled to begin recording;
in response to determining that the first time reflects the time at which the program is scheduled to begin recording, (a) tuning to a channel on which the program will be broadcast and (b) storing, on a persistent storage device, content that is being broadcasted on the channel;
determining, at a second time, that the second time reflects a time that a user instructed the digital video recording device to stop recording the program; and
in response to determining that the second time reflects the time that the user instructed the digital video recording device to stop recording the program, ending a recording of the content that the digital video recording device had been storing on the persistent storage device up until the second time;
wherein the second time differs from a time that an electronic programming guide indicated that a broadcast of the program would conclude.

30. A volatile or non-volatile computer-readable storage medium carrying instructions which, when executed by one or more processors, cause the processors to perform steps comprising:
determining that a program that a digital video recording device has been instructed to record has a particular characteristic associated with the program;
in response to determining that the program has the particular characteristic, automatically extending an original scheduled recording time interval for the program by a specified amount of time, thereby producing an extended scheduled recording time interval that is longer in duration than the original scheduled recording time interval;
wherein the original scheduled recording time interval, prior to the extension, is based on a duration of the program as indicated in electronic programming guide data; and
recording the program in accordance with the extended scheduled recording time interval instead of the original scheduled recording time interval.
